(19) United States
(12) Patent Application Publication
(10) Pub. No.: US 2024/0251483 A1
(43) Pub. Date: Jul. 25, 2024

(54) VEHICLE WINDOW GLASS

(71) Applicant: NIPPON SHEET GLASS COMPANY, LIMITED, Tokyo (JP)

(72) Inventors: Motoki IZUMI, Tokyo (JP); Yoshinobu TSURUME, Tokyo (JP)

(73) Assignee: NIPPON SHEET GLASS COMPANY, LIMITED, Tokyo (JP)

(21) Appl. No.: 18/561,556

(22) PCT Filed: May 17, 2022
(86) PCT No.: PCT/JP2022/020588

§ 371 Date: Nov. 16, 2023

(30) Foreign Application Priority Data
May 17, 2021 (JP) 2021-083530

(51) Int. Cl. H05B 3/84; H01Q 1/12; H01Q 1/32; H01Q 1/38; H01Q 21/28

(52) U.S. Cl. CPC H05B 3/84; H01Q 1/1278; H01Q 1/325; H01Q 1/38; H01Q 21/28; H05B 2203/011

(57) ABSTRACT

A vehicle window glass according to the present invention is provided with: a glass plate; a light-shield layer stacked on a peripheral portion of the glass plate; a defogger of which at least a part is disposed in a light-transmissive region of the glass plate surrounded by the light-shield layer; and a first antenna disposed lower than the defogger on the glass plate. The vertical width of a part of the light-shield layer stacked on an upper end portion of the glass plate is 25 to 200 mm. The vehicle window glass satisfies a1+b1≥0.5λ, where a1 is the shortest of the horizontal lengths of the light-transmissive region, b1 is the vertical length of the light-transmissive region, and λ is the wavelength of radio waves received by the first antenna.

### TECHNICAL FIELD

The present invention relates to a vehicle window glass.

### BACKGROUND ART

Various antennas are provided on a surface of a vehicle window glass (in particular, rear glass) attached to an automobile. For example, an antenna for receiving broadcasting of various media such as FM broadcasting, AM broadcasting, and digital television broadcasting is provided. For example, in Patent Document 1, an antenna for receiving FM broadcasting, AM broadcasting, and digital television broadcasting is provided.

### PRIOR ART DOCUMENTS

### Patent Documents

Patent Document 1: Japanese Patent No. 51098305

### SUMMARY OF THE INVENTION

### Problems to be Solved by the Invention

Meanwhile, in a window glass of Patent Document 1, various antennas are provided above a defogger. On the other hand, since a receiver of an antenna is often provided below a window glass, when the antenna is provided above a defogger, it is necessary to lengthen a wiring connecting the antenna and the receiver, and this wiring may adversely affect reception performance. The present invention has been made to solve the above problems, and an object of the present invention is to provide a vehicle window glass capable of improving the reception performance of an antenna.

### Means for Solving the Problem

Item 1. A vehicle window glass including:
a glass plate;
a light shielding layer laminated on a peripheral edge portion of the glass plate;
a defogger at least partially disposed in a light-transmissive region surrounded by the light shielding layer in the glass plate; and
a first antenna disposed below the defogger in the glass plate,
in which, in the light shielding layer, a width in a vertical direction of a portion laminated on an upper end portion of the glass plate is 25 to 200 mm, and
a1+b1≥0.5λ is satisfied, where in the light-transmissive region, a1 is a horizontal length at a center portion of the glass plate in a vertical direction, b1 is a vertical length at a center portion of the glass plate in a horizontal direction, and k is a wavelength of a center frequency of a radio wave received by the first antenna.

Item 2. The vehicle window glass according to item 1, in which
the first antenna includes;
a first connection point;
a second connection point;
a first element extending from the first connection point; and
a second element extending from the second connection point, and
the first element includes a first portion extending downward from the first connection point, a second portion extending in the horizontal direction from a lower end portion of the first portion, a third portion extending upward from an end portion of the second portion, and a fourth portion extending to a side of the first connection point from an upper end of the third portion.

Item 3. The vehicle window glass according to item 2, in which the first element further includes a fifth portion connected to an upper end portion of the third portion and extending in the horizontal direction in a direction away from the first connection point.

Item 4. The vehicle window glass according to item 2 or 3, in which the first antenna includes a digital television antenna, and a total length of the first portion to the fourth portion is in a range of 0.75κ·λ to 1.30κ·λ, where κ is a wavelength shortening rate in glass.

Item 5. The vehicle window glass according to item 3, in which the first antenna includes a digital television antenna, and a total length of the first portion to the fifth portion is in a range of 0.95κ·λ to 1.33κ·λ, where κ is a wavelength shortening rate in glass.

Item 6. The vehicle window glass according to any one of items 2 to 5, further including at least one parasitic element extending in the horizontal direction above the fourth portion of the first element.

Item 7. The vehicle window glass according to any one of items 1 to 6, further including
a second antenna,
in which the first antenna and the second antenna are disposed so as to sandwich a center of the glass plate in the horizontal direction, and
the first antenna and the second antenna have an asymmetric shape with the center interposed between the first antenna and the second antenna.

Item 8. The vehicle window glass according to item 7, in which the first antenna and the second antenna are configured to receive a broadcast wave in a UHF band.

Item 9. The vehicle window glass according to item 7, in which the first antenna and the second antenna are configured to receive a horizontally polarized wave.

Item 10. The vehicle window glass according to any one of items 7 to 9, in which
the defogger includes a pair of bus bars and a plurality of heating wires extending between the pair of bus bars and arranged in parallel in the vertical direction,
the first antenna is disposed below a lowermost heating wire of the heating wires, and
the second antenna is disposed between the lowermost heating wire and a second heating wire from a bottom of the heating wires.

Item 11. The vehicle window glass according to any one of items 7 to 10, in which
the second antenna includes:
a third connection point;
a fourth connection point;
a third element extending from the third connection point; and
a fourth element extending from the fourth connection point, and
the third element includes a sixth portion extending upward from the third connection point, and a seventh portion extending in the horizontal direction from an upper end of the sixth portion.

Item 12. The vehicle window glass according to item 2 or 3, in which
the first antenna includes a DAB antenna, and
a total length of the first portion to the fourth portion is in a range of 0.22κ·λ to 0.32κ·λ, where x is a wavelength shortening rate in glass.

Item 13. The vehicle window glass according to item 3, in which
the first antenna includes a DAB antenna, and
a total length of the first portion to the fifth portion is in a range of 0.32κ·λ to 0.43κ·λ, where x is a wavelength shortening rate in glass.

### Advantages of the Invention

The vehicle window glass according to the present invention can improve the reception performance of an antenna.

### BRIEF DESCRIPTION OF THE DRAWINGS

FIG. 1 is a front view illustrating an embodiment in which a vehicle window glass according to the present invention is applied to a rear glass of an automobile on which a digital television antenna is disposed.

FIG. 2 is an enlarged view of a lower portion of the rear glass of FIG. 1.

FIG. 3 is a front view illustrating an embodiment in which the vehicle window glass according to the present invention is applied to a rear glass of an automobile in which a DAB antenna is disposed.

FIG. 4 is an enlarged view of a lower portion of the rear glass of FIG. 3.

FIG. 5 is a schematic diagram illustrating a testing machine for examining dimensions of a light-transmissive region.

FIG. 6 is a graph illustrating a test regarding dimensions of a light-transmissive region.

FIG. 7 is a diagram illustrating a first digital television antenna according to Examples 1 to 5.

FIG. 8 is a graph illustrating reception performance of Examples 1 to 5.

FIG. 9 is a diagram illustrating a first digital television antenna according to Example 6 to 10.

FIG. 10 is a graph illustrating reception performance of Example 6 to 10.

FIG. 11A is a diagram illustrating a first digital television antenna according to Example 11.

FIG. 11B is a diagram illustrating a first digital television antenna according to Example 12.

FIG. 11C is a diagram illustrating a first digital television antenna according to Embodiment 13.

FIG. 12 is a graph illustrating reception performance of Examples 11 to 14.

FIG. 13 is a diagram illustrating a DAB antenna according to Examples 15 to 21.

FIG. 14 is a graph illustrating reception performance of Examples 15 to 21.

FIG. 15 is a diagram illustrating a DAB antenna according to Examples 22 to 25.

FIG. 16 is a graph illustrating reception performance of Examples 22 to 25.

### EMBODIMENTS OF THE INVENTION

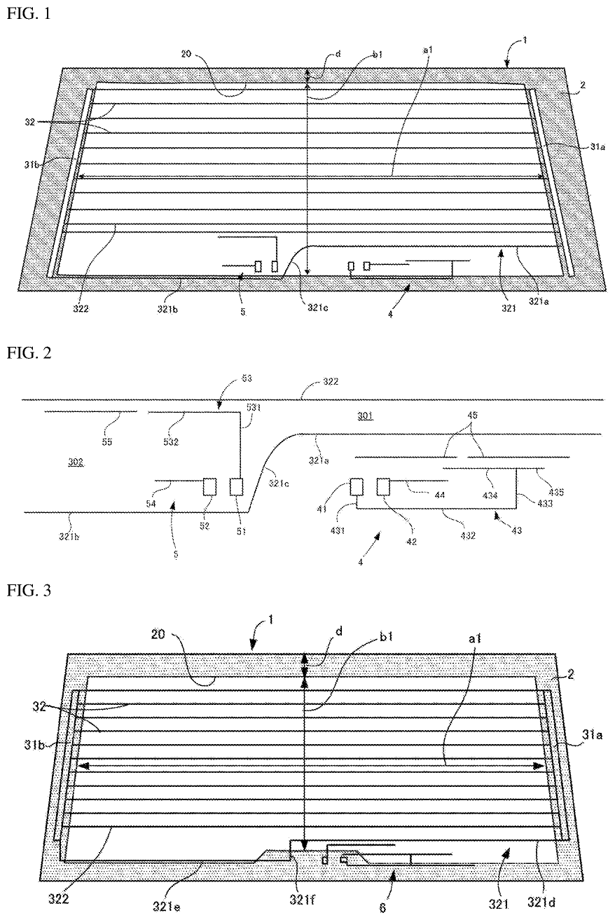

Hereinafter, an embodiment of a vehicle window glass according to the present invention will be described with reference to the drawings. FIG. 1 is a front view of a rear glass of an automobile to which a vehicle window glass according to the present embodiment is applied as viewed from an outside of the automobile. Note that hereinafter, for convenience of description, an up-down direction in FIG. 1 may be referred to as an up-down direction or a vertical direction, and a left-right direction in FIG. 1 may be referred to as a left-right direction or a horizontal direction with reference to the direction in FIG. 1, but this direction does not limit the present invention. For example, terms “vertical direction” and “horizontal direction” in the following description include not only a strict vertical direction and horizontal direction but also a slight deviation from the vertical direction and the horizontal direction.

### <1. Rear Glass>

As illustrated in FIG. 1, in the rear glass according to the present embodiment, a light shielding layer 2, a defogger 3, a first digital television antenna 4, and a second digital television antenna 5 are disposed on a glass plate 1. Hereinafter, each member will be described in order.

### <1-1. Glass Plate>

As the glass plate 1, a known glass plate for an automobile can be used. For example, as the glass plate 1, heat-ray absorbing glass, general clear glass or green glass, dark privacy glass, or UV green glass may be used. However, such a glass plate 1 needs to realize visible light transmittance conforming to a safety standard of a country in which an automobile is used. For example, the solar absorptivity, the visible light transmittance, and the like can be adjusted to satisfy the safety standards. Hereinafter, an example of a composition of the clear glass and an example of a composition of the heat-ray absorbing glass will be described.

### (Clear Glass)

SiO₂: 70 to 73 mass %

Al₂O₃: 0.6 to 2.4 mass %

CaO: 7 to 12 mass %

MgO: 1.0 to 4.5 mass %

R²O: 13 to 15 mass % (R is an alkali metal)

Total iron oxide (T-Fe₂O₃) in terms of Fe₂O₃: 0.08 to 0.14 mass %

### (Heat-Ray Absorbing Glass)

The composition of the heat-ray absorbing glass can be, for example, a composition obtained by setting a ratio of total iron oxide (T-Fe₂O₃) in terms of Fe₂O₃ to 0.4 to 1.3 mass %, a ratio of CeO₂ to 0 to 2 mass %, a ratio of TiO₂ to 0 to 0.5 mass %, and subtracting the skeleton components (mainly SiO₂ and Al₂O₃) of the glass by an increase amount of T-Fe₂O₃, CeO₂, and TiO₂ based on the composition of the clear glass.

Note that the type of the glass plate 1 is not limited to the clear glass or the heat-ray absorbing glass, and can be appropriately selected according to the embodiment. For example, the glass plate 1 may be an acrylic resin window, a polycarbonate resin window, or the like.

Furthermore, such a glass plate 1 may be formed of a single glass plate, or may be a laminated glass in which an interlayer film such as a resin is sandwiched between a plurality of glasses.

### <1-2. Light Shielding Layer>

In the present embodiment, the light shielding layer 2 is formed along a peripheral edge portion of a surface on a vehicle interior side of the glass plate 1, and forms a rectangular light-transmissive region 20 surrounded by the light shielding layer 2. As a result, the inside of the vehicle is not visible from the outside through a region where the light shielding layer 2 is formed. On the other hand, the inside of the vehicle can be seen from the outside of the vehicle or the outside of the vehicle can be seen from the inside of the vehicle through the light-transmissive region 20 where the light shielding layer 2 is not formed. As a result, for example, components such as wiring disposed on a surface of the light shielding layer 2 on the vehicle interior side can be made invisible from the outside. A material of the light shielding layer 2 may be appropriately selected according to the embodiment as long as it can shield a visual field from the outside, and for example, a dark color ceramic such as black, brown, gray, and deep blue may be used. In addition, a sheet material can be attached.

In a case where black ceramic is selected as the material of the light shielding layer 2, for example, black ceramic is laminated on the surface of the glass plate 1 on the vehicle interior side by screen printing or the like, and the laminated ceramic is heated together with the glass plate 1. Then, when the ceramic is cured, the light shielding layer 2 is completed. Note that, although various materials can be used as the ceramic used for the light shielding layer 2, for example, a ceramic having a composition shown in Table 1 below can be used for the light shielding layer 2.

TABLE 1

| | | First and second |
|---|---|---|
| | | colored ceramic paste |
| Pigment *1 | Mass % | 10 |
| Resin (cellulose resin) | Mass % | 10 |
| Organic solvent (pine oil) | Mass % | 10 |
| Glass binder *2 | Mass % | 10 |
| Viscosity | dPs | 150 |

*1, Main component: Copper oxide, chromium oxide, iron oxide, and manganese oxide
*2, Main component: Bismuth borosilicate, zinc borosilicate

A width d of a center in the horizontal direction of a portion along an upper end portion of the glass plate 1 in the light shielding layer 2 can be, for example, 25 to 200 mm. Furthermore, a length b1 of the light-transmissive region 20 in the vertical direction at a center of the glass plate 1 in the horizontal direction can be, for example, 300 to 1200 mm, and a length a1 of the light-transmissive region 20 in the horizontal direction at a center of the glass plate 1 in the vertical direction can be, for example, 500 to 1500 mm.

In the present embodiment, the following Formula (1) is satisfied. Note that λ is a wavelength of a center frequency of a broadcast wave received by digital television antennas 4 and 5 described later.

$$\\ \begin{matrix}a 1 + b 1 \geq 0.5 λ & ( 1 )\end{matrix}$$

### <1-3. Defogger>

Next, the defogger 3 will be described. As illustrated in FIG. 1, the defogger 3 includes a pair of power supply bus bars 31a and 31b extending in the vertical direction along both side edges of the glass plate 1. A plurality of heating wires 32 are arranged in parallel at predetermined intervals between both bus bars 31a and 31b, and heat for defogging is generated on the surface of the glass plate 1 by power supply from the bus bars 31a and 31b. Both the bus bars 31a and 31b are formed in the light shielding layer 2 and are not visible from the outside of the vehicle.

Among the heating wires 32, a lowermost heating wire 321 is formed by three portions. That is, a first portion 321a on the right side, a second portion 321b on the left side, and a third portion 321c connecting the first portion 321a and the second portion 321b are included. The first portion 321a and the second portion 321b extend substantially horizontally, and extend from the bus bars 31a and 31b to the vicinity of a center of the light-transmissive region 20. The third portion 321c extends obliquely so as to connect the first portion 321a and the second portion 321b. With this shape, a gap between the first portion 321a and a second heating wire 322 extending in the horizontal direction from the bottom is narrow, and a gap between the second portion 321b and the second heating wire 322 from the bottom is wide. Hereinafter, a gap between the second heating wire 322 from the bottom and the first portion 321a is referred to as a first gap 301, and a gap between the second heating wire 322 from the bottom and the second portion 321b is referred to as a second gap 302. Furthermore, the second portion 321b is formed in the light shielding layer 2.

### <1-4. First Digital Television Antenna>

FIG. 2 is an enlarged view of the vicinity of a lower end portion of the rear glass. As illustrated in FIGS. 1 and 2, a first digital television antenna 4 is disposed below the first portion 321a of the lowermost heating wire 321. More specifically, the first digital television antenna 4 includes a first connection point 41 connected to a central conductor of a coaxial cable or an input unit of an amplifier circuit, a second connection point 42 connected to an external conductor of the coaxial cable directly or via the amplifier circuit, a first element 43 extending from the first connection point 41, a second element 44 extending from the second connection point 42, and one or a plurality of parasitic elements 45 not connected to the first connection point 41 and the second connection point 42.

The first connection point 41 is disposed near the center of the glass plate 1, and the second connection point 42 is disposed on the right side of the first connection point. The first element 43 includes a first portion 431 extending from the first connection point 41 to a glass extending portion (downward), a second portion 432 extending horizontally rightward from a lower end of the first portion 431, a third portion 433 extending upward from a right end of the second portion 432, a fourth portion 434 extending leftward from an upper end of the third portion 433, and a fifth portion 435 extending rightward from the upper end of the third portion 433. The second portion 432 is disposed closer to the glass extending portion (lower side) than the second connection point 42 and the second element 44, and extends to a right side of the second element 44. Furthermore, as illustrated in FIG. 1, the second portion 432 is formed in the light shielding layer 2.

A total length of the first portion 431 to the fifth portion 435 of the first element 43 can be, for example, 0.95κ·λ to 1.33κ·λ, and this can improve the reception performance. Note that κ is a wavelength shortening rate unique to glass, and is usually a value of 0.6 to 0.7.

In the present embodiment, two parasitic elements 45 are formed as an example. Each of them is formed of a linear filament extending in the horizontal direction, and two filaments are disposed above the fourth portion 434 of the first element 43 so as to be aligned in the horizontal direction.

The second element 44 extends horizontally rightward from the second connection point 42, and is disposed below the fourth portion 434 of the first element 43. In the present embodiment, the second element 44 and the fourth portion 434 are formed so as to overlap each other in the horizontal direction, but may be separated in the horizontal direction so as not to overlap each other.

Furthermore, an amplifier circuit (not illustrated) for a digital television broadcast wave is provided in the automobile to which the rear glass is attached, and the first connection point 41 is connected to a signal input unit of the amplifier circuit directly or via a central conductor of a coaxial cable (not illustrated). On the other hand, the second connection point 42 is electrically connected to a circuit board of the amplifier circuit. The same applies to the second digital television antenna 5 described below. Note that the first connection point 41 and the second connection point 42 may be connected to both ends of an input unit of a balance circuit represented by a balun circuit or the like. Note that the amplifier circuit is disposed near the center below the glass plate 1.

### <1-5. Second Digital Television Antenna>

As illustrated in FIGS. 1 and 2, the second digital television antenna 5 is disposed in the second gap 302 described above. More specifically, the second digital television antenna 5 includes a third connection point 51, a fourth connection point 52, a third element 53 extending from the third connection point 51, a fourth element 54 extending from the fourth connection point 52, and one or a plurality of parasitic elements 55.

The third connection point 51 is disposed near the center of the glass plate 1, and the fourth connection point 52 is disposed on a left side of the third connection point. The third element 53 includes a sixth portion 531 extending upward from the third connection point 51 and a seventh portion 532 extending horizontally leftward from an upper end of the sixth portion 531.

The fourth element 54 extends horizontally leftward from the fourth connection point 52. Furthermore, the seventh portion 532 extends further to the left side than the fourth element 54.

In the present embodiment, one parasitic element 55 is formed. The parasitic element 55 is formed of a linear filament extending in the horizontal direction, and is disposed on the left side of the seventh portion 532.

### <1-6. Materials>

The defogger 3 and each of the digital television antennas 4 and 5 as described above are configured by combining wire materials, but these can be formed by laminating a conductive material having conductivity so as to have a predetermined pattern on the surface of the glass plate 1. Such a material only needs to have conductivity, and can be appropriately selected according to the embodiment, and examples thereof include silver, gold, and platinum. Specifically, for example, conductive ink containing silver powder, glass frit, or the like can be formed by printing and firing on the surface of the glass plate 1.

### <1-7. Manufacturing Method>

Next, a method of manufacturing a window glass according to the present embodiment will be described. The glass plate 1 of the window glass according to the present embodiment can be formed by a press molding method in which glass is heated to a softening point and then molded by pressing along an intended arbitrary shape, a self-weight bending method in which the glass plate 1 is bent by its own weight, or the like.

Here, when the glass plate 1 is molded in each method, the glass plate 1 is heated up to the vicinity of the softening point in a heating furnace. Before being carried into the heating furnace, the glass plate 1 is formed in a flat plate shape, and the ink for each material described above, for example, a conductive ink is printed on the surface of the glass plate 1. Then, the glass plate 1 is carried into the heating furnace to mold the glass plate 1, and the conductive ink printed on the glass plate 1 is fired to form the defogger 3 and the digital television antennas 4 and 5. Note that the colored ceramic paste for forming the light shielding layer 2 is printed on the glass plate 1 before heating formed on a flat plate, similarly to the conductive ink for forming the antennas 4 and 5 and the like. Furthermore, by laminating and printing the colored ceramic paste and a plurality of types of conductive inks, a lamination of the light shielding layer and the conductor layer can be formed on the glass surface.

### <2. Features>

As described above, according to the present embodiment, the following effects can be obtained.

(1) Since the two digital television antennas 4 and 5 are disposed below or at a bottom of the defogger 3, for example, the wiring (transmission cable) to the amplifier circuit can be shortened as compared with the case where these are disposed above the defogger 3. For example, when these digital television antennas 4 and 5 are disposed above the defogger 3, at least a length of the wiring becomes a1+b1. The inventors of the present invention have confirmed that when the length of a1+b1 is 0.5λ or more, the reception performance is deteriorated. Note that, as in the present embodiment, when the width d of the center in the horizontal direction of the portion of the light shielding layer 2 along the upper end portion of the glass plate 1 is 25 to 200 mm, it is difficult to dispose the antennas.

(2) The two digital television antennas 4 and 5 of the present embodiment have an asymmetric shape with the center interposed between the first antenna and the second antenna. Therefore, a frequency band to be received can be changed, and a broadcast wave in a wider frequency band can be received.

(3) The two digital television antennas 4 and 5 can receive the broadcast wave of the digital television in a UHF band. Furthermore, a horizontally polarized wave can be received. In particular, since the first element 43 is formed into a substantially U shape from the first connection point 41 as described above, the first digital television antenna 4 is configured to be suitable for the reception of the broadcast wave in a relatively low frequency band (for example, 470 to 575 MHz) out of the frequency bands 470 MHz to 710 MHz used for the broadcast service. On the other hand, the second digital television antenna 5 is formed such that the third element 53 extends upward from the third connection point 51, and is configured to be suitable for the reception of the broadcast wave in a relatively high frequency band (for example, 575 to 710 MHz).

### <3. Modifications>

Although one embodiment of the present invention has been described above, the present invention is not limited to the above embodiment, and various modifications can be made without departing from the gist thereof. Note that the following modifications can be appropriately combined.

(1) In the first element 43 of the first digital television antenna 4, the fifth portion 435 may not be provided, and at least the first portion 431 to the fourth portion 434 may be provided. In this case, in order to improve the reception performance, the total length of the first portion 431 to the fourth portion 434 is preferably 0.75κ·λ to 1.30κ·λ described above.

(2) In the first digital television antenna 4, the parasitic element 45 is not necessarily required and may not be provided, but in a case where the parasitic element is provided, its shape, position, and number are not particularly limited. For example, the parasitic element is formed of linear filaments extending in the horizontal direction and two parasitic elements are disposed above the fourth portion 434 of the first element 43, and the two parasitic elements may be disposed in the vertical direction, or the two parasitic elements may be disposed in the horizontal direction. The shape of the second element 44 is not particularly limited, and may be various shapes other than a linear shape.

(3) A shape of the second digital television antenna 5 is not particularly limited. For example, at least one linear element may be added to the third element 53. That is, at least one linear element can be connected to the sixth portion 531 in parallel with the seventh portion 532. The shape of the fourth element 54 is also not particularly limited, and various shapes other than the linear shape can be adopted. Furthermore, the parasitic element 55 is not necessarily required and may not be provided, but in a case where the parasitic element is provided, the shape, position, and number thereof are not particularly limited. In a case where the parasitic elements are provided, the parasitic elements can be disposed on the left side of the third element 53 at an interval in the vertical direction in parallel. By providing such a plurality of the parasitic elements or a plurality of elements in the sixth portion 531, the reception performance can be improved.

(4) The form of the defogger 3 of the above embodiment is an example, and the number of heating wires 22 is not particularly limited. Furthermore, in order to improve reception sensitivity, a heating wire extending in the vertical direction can be added. Furthermore, in the above embodiment, a part of the defogger 3 is located in the light shielding layer 2, but a portion to be arranged in the light shielding layer may be appropriately determined. Thus, all of the defoggers 3 can also be arranged in the light-transmissive region 20. Alternatively, the defogger 3 may have a horizontally inverted shape from that of the above embodiment. That is, the first gap 301 can be disposed on the left side, and the second gap 302 can be disposed on the right side. Correspondingly, the first digital television antenna 4 may be located on the left side, and the second digital television antenna 5 may be located on the right side.

(5) In the above embodiment, the light shielding layer 2 is formed on the glass plate 1, but a cover may be provided on the peripheral edge portion of the glass plate together with the light shielding layer or without providing the light shielding layer. In a case where the cover is provided as described above, the defogger 3 and the digital television antennas 4 and 5 can be arranged mainly in the light-transmissive region surrounded by the cover. In the light-transmissive region 20 surrounded by the cover, when a length in the horizontal direction at the central portion in the vertical direction of the glass plate 1 is represented by a2, and a length in the vertical direction at the central portion in the horizontal direction of the glass plate 1 is represented by b2, the present inventors have found that when a2+b2≥0.5λ is satisfied, the reception performance is deteriorated. Note that a2 and b2 can be set similarly to a1 and b1 as described above.

(6) In the above embodiment, the broadcast wave of the digital television is received by the two digital television antennas, but only the first digital television antenna 4 may be used as long as at least the width d and Formula (1) are satisfied.

(7) In the above embodiment, the case where the digital television antennas 4 and 5 are provided below or at a bottom of the defogger 3 has been described, but this point is the same for other than the digital television antenna. That is, it has been confirmed by the present inventors that even if an FM antenna, an AM antenna, or a DAB antenna is disposed above the defogger 3, a wiring with a reception device disposed below the glass plate 1 becomes long, which adversely affects the reception performance. Therefore, the first antenna in the present invention may be the FM antenna, the AM antenna, or the DAB antenna other than the digital television antenna.

(8) In a case where a vertically polarized DAB (175 to 240 MHz, center wavelength 207 MHz) antenna is used instead of the digital television antenna, for example, the above-described “when the antenna is disposed above the defogger 3, at least the length of the wiring becomes a1+b1. When the length of a1+b1 is 0.5λ or more, the reception performance is deteriorated” is similarly applied to the DAB antenna.

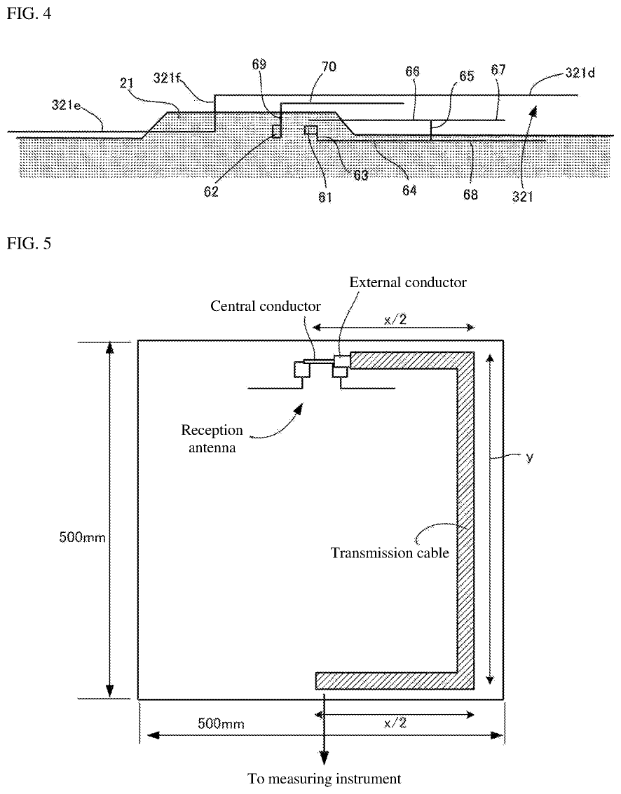

(9) As an example of the vehicle window glass using the DAB antenna, for example, a vehicle window glass as illustrated in FIGS. 3 and 4 can be exemplified. FIG. 3 is a front view of a vehicle window glass on which a DAB antenna is disposed. The above-described vehicle window glass illustrated in FIG. 1 and FIG. 3 are different in that a shape of a lowermost heating wire 321, a shape of a light shielding layer 2, and a DAB antenna 6 instead of the digital television antenna are provided below the defogger.

First, in this example, the lowermost heating wire 321 includes a right first portion 321d, a left second portion 321e, and a third portion 321f connecting the first portion 321d and the second portion 321e. The first portion 321d and the second portion 321e extend in the substantially horizontal direction, and extend from the bus bars 31a and 31b to the vicinity of the center of the light-transmissive region 20. The third portion 321f extends in the vertical direction so as to connect the first portion 321d and the second portion 321e. With this shape, a gap between the first portion 321d and the second heating wire 322 extending in the horizontal direction from the bottom is narrow, and a gap between the second portion 321e and the second heating wire 322 from the bottom is wide.

The light shielding layer 2 is different from the light shielding layer 2 in FIG. 1 in that a trapezoidal protrusion 21 protruding upward is formed at the center of the lower edge of the light-transmissive region 20 formed by the light shielding layer 2.

FIG. 4 is an enlarged view of the vicinity of a lower end portion of the rear glass. As illustrated in FIGS. 3 and 4, the DAB antenna 6 is disposed below the first portion 321a of the lowermost heating wire 321. More specifically, the DAB antenna 6 includes a first connection point 61 connected to the central conductor of the coaxial cable or the input unit of the amplifier circuit, and a second connection point 62 connected to the outer conductor of the coaxial cable directly or via the amplifier circuit, and both the connection points are disposed on the protrusion 21. An element including six portions is connected to the first connection point 61. That is, there are provided a first portion 63 extending slightly downward from the first connection point 61, a second portion 64 extending horizontally rightward from the first portion 63, a third portion 65 extending upward from the second portion 64, a fourth portion 66 extending horizontally leftward (to a side of the first connection point 61) from an upper end of the third portion 65, a fifth portion 67 extending horizontally rightward from the fourth portion 66, and a sixth portion 68 extending horizontally rightward from the second portion 64. Among them, the first portion 63, the second portion 64, and the sixth portion 68 are disposed in the light shielding layer 2, and a lower end portion of the third portion 65 is disposed in the light shielding layer 2. A left end portion of the fourth portion 66 is disposed in the protrusion 21. The fifth portion 67 is disposed in the light-transmissive region 20.

An element including two portions is connected to the second connection point 62. That is, a seventh portion 69 extending upward from the second connection point 62 and an eighth portion 70 horizontally extending rightward from an upper end of the seventh portion 69 are provided. Among them, a lower end portion of the seventh portion 69 is disposed in the light shielding layer 2, and the eighth portion 70 is disposed in the light-transmissive region 20.

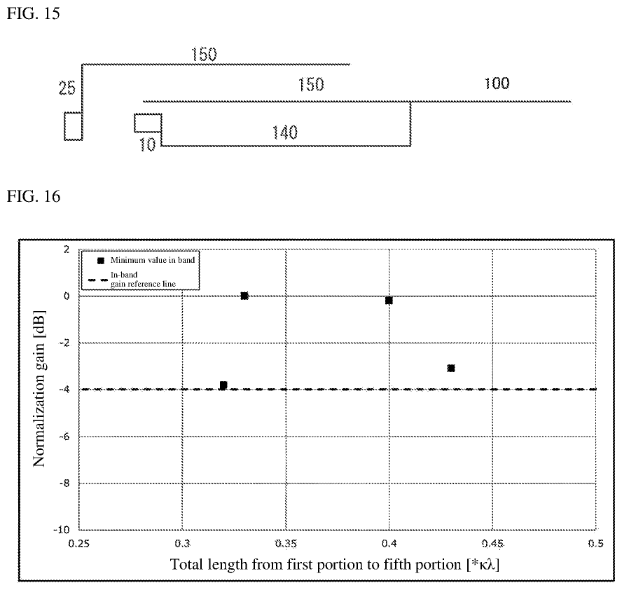

However, the shapes of the DAB antenna, the defogger, and the light shielding layer illustrated in FIGS. 3 and 4 are examples, and can be appropriately changed. For example, the DAB antenna illustrated in FIGS. 3 and 4 can be changed as appropriate. For example, the fifth portion 67 and the sixth portion 68 can be eliminated (FIG. 13 to be described later), or the sixth portion 68 can be eliminated (FIG. 15 to be described later).

Note that a difference between the digital television antenna and the DAB antenna is mainly a difference in wavelength of a received broadcast wave. For example, a total length of the first to fourth portions or the first to fifth portions is preferably in a certain length range as an absolute length regardless of the digital television antenna or the DAB antenna as described later. Furthermore, from a difference between the center wavelengths (λ) of the digital television antenna and the DAB antenna, when the length is described by a multiple of κ·λ, a coefficient of κ·λ also changes corresponding to the wavelength difference. For example, the center wavelengths of the digital television antenna and the DAB antenna are nearly three times different, and the coefficients of κ·λ are also nearly three times different.

Furthermore, in the vehicle window glass of FIG. 3, the digital television antenna 4 illustrated in FIG. 1, an FM antenna, an AM antenna, or the like can be disposed instead of the DAB antenna 6.

(10) In the above embodiment, the present invention is applied to the rear glass, but can also be applied to a window glass other than the rear glass.

### EXAMPLES

Hereinafter, examples of the present invention will be described. However, the present invention is not limited to the following examples.

### <1. Study on Dimension of Light-Transmissive Region>

The influence on the reception level due to a length of a transmission cable connected to a reception antenna was evaluated as follows. First, as illustrated in FIG. 5, a glass plate having a size of 500×500 mm and a thickness of 5 mm was prepared, and printed and fired with a conductive ink at the central upper portion to prepare a reception antenna. This reception antenna has two connection points, and linear elements are connected so as to be separated from each other in the horizontal direction from each connection point.

A transmission cable (coaxial cable) having a total horizontal length of x and a vertical length of y was attached to the reception antenna (a total length of the transmission cable is x+y). That is, a central conductor was connected to one connection point, and an external conductor was connected to the other connection point. Next, a test wave of a horizontally polarized wave in a frequency band of 470 to 710 MHz was irradiated from a transmission antenna (not illustrated) toward the reception antenna, a signal level received through the transmission cable was defined as a pass characteristic, and measurement was performed by a network analyzer.

The evaluation was performed with a reception gain fluctuation range. This is an evaluation method of quantifying and evaluating a change amount of a reception gain when the horizontal length x and the vertical length y are changed under the condition of a certain constant cable length.

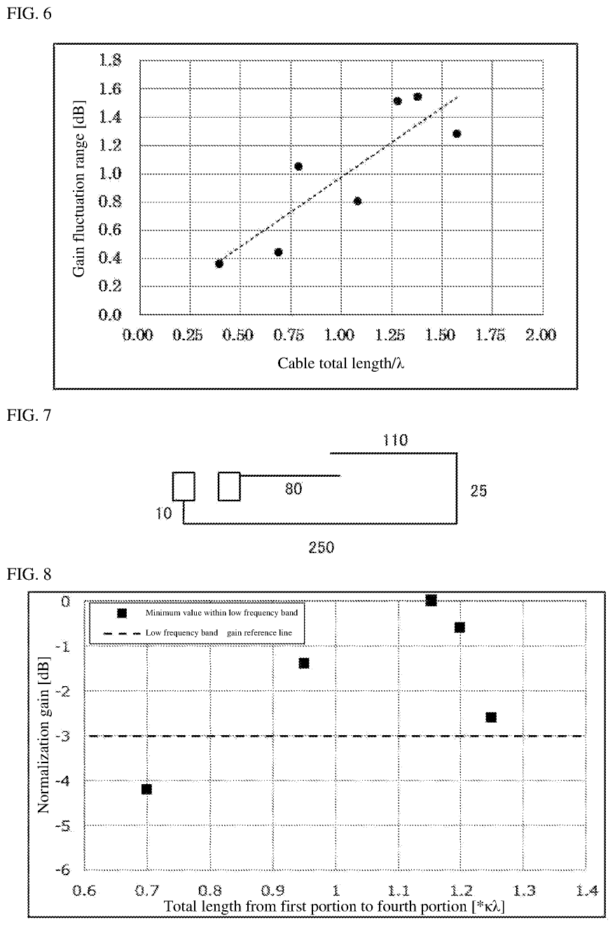

As a result, as illustrated in FIG. 6, it has been found that as the total length x+y of the transmission cable increases, the value of the reception gain fluctuation range also increases. That is, when a state of the transmission cable changes even slightly and the lengths of x and y change, the influence on the reception performance of the antenna increases. Since the transmission cable is also a conductor, when the length exceeds a certain length, the cable itself starts to function as an antenna, and the influence on the performance of the original reception antenna is considered to increase.

In particular, in an antenna that receives a radio wave of a digital television in a frequency band of 470 to 710 MHz, according to another finding of the inventors, it has been found that when the reception gain variation range exceeds 0.5 dB, an adverse effect such as the need for an adjustment mechanism on a side of a circuit to be connected occurs, which is not preferable. From the results illustrated in FIG. 6, it has been found that a length of the transmission cable at this time is approximately 0.5×λ (λ is a wavelength of a center frequency of 590 MHz of a radio wave of 470 to 710 MHz). Therefore, in the vehicle window glass including the light-transmissive region satisfying the above Formula (1), it has been found that the reception performance is improved when the antenna is provided below the defogger. Note that, although this study is performed on the digital television antenna, a similar result is obtained in a DAB antenna.

### <2. Study 1 on Shape of First Digital Television Antenna>

Hereinafter, a total length of the first to fourth portions of the first element of the first digital television antenna as illustrated in FIG. 7 has been studied. In Examples 1 to 5, the total lengths of the first to fourth portions are approximately 0.7κ·λ, 0.95κ·λ, 1.1κ·λ, 1.2κ·λ, and 1.25κ·λ, respectively. FIG. 7 illustrates Example 3 (the unit of the numerical value is mm), and in Examples 1, 2, 4, and 5, the lengths of the first to fourth portions are adjusted so as to have the above-described total length based on the dimension illustrated in Example 3. Note that the wavelength shortening rate κ of the glass plate is 0.7, the center frequency of the test wave (470 to 710 MHz) is 590 MHz, and the wavelength thereof is λ (=509 mm). This point is the same in Examples described later.

Each of the first digital television antennas of Examples 1 to 5 was formed on a glass plate. Then, each glass plate was assembled to a window frame of an automobile, directional characteristics on a horizontal plane were measured while changing an irradiation angle of a radio wave, and an average gain was calculated. The measurement of the directional characteristics was performed in a frequency band of 470 to 710 MHz. Results are as illustrated in FIG. 8. Note that FIG. 8 illustrates the results in a low frequency range (470 to 575 MHz).

According to FIG. 8, it has been found that a total length from the first portion to the fourth portion is preferably 0.75κ·λ to 1.30κ·λ as a range in which a normalization gain as a reference is −3 dB or more.

### <3. Study 2 on Shape of First Digital Television Antenna>

Hereinafter, a total length of the first to fifth portions of the first element of the first digital television antenna as illustrated in FIG. 9 has been studied. In Examples 6 to 10, the total lengths of the first to fifth portions are approximately 0.9κ·λ, 1.0 κ·λ, 1.1κ·λ, 1.25κ·λ, and 1.35κ·λ, respectively. FIG. 9 illustrates Example 9 (the unit of the numerical value is mm), and in Examples 6 to 8 and 10, the lengths of the first to fifth portions are adjusted so as to have the above-described total length based on the dimension illustrated in Example 9.

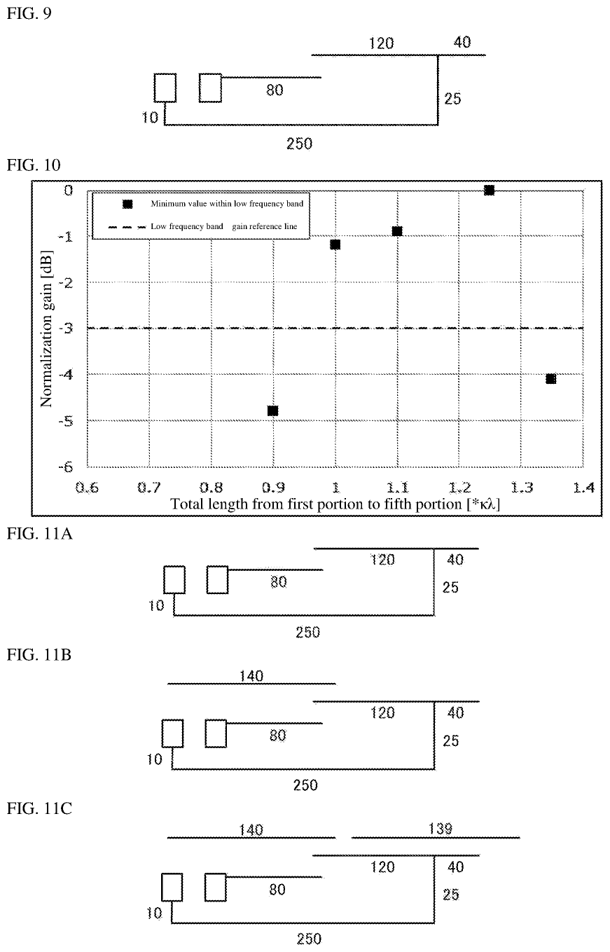

Each of the first digital television antennas of Examples 6 to 10 was formed on a glass plate. Then, each glass plate was assembled to a window frame of an automobile, directional characteristics on a horizontal plane were measured while changing an irradiation angle of a radio wave, and an average gain was calculated. The measurement of the directional characteristics was performed in a frequency band of 470 to 710 MHz. Results are as illustrated in FIG. 10. Note that FIG. 10 illustrates the results in the low frequency range (470 to 575 MHz).

According to FIG. 10, it has been found that the total length from the first portion to the fifth portion is preferably 0.95κ·λ to 1.33κ·λ as a range in which a normalization gain as a reference is −3 dB or more.

<4. Study 3 on shape of first digital television antenna>

Hereinafter, the number of parasitic elements of the first element of the first digital television antenna is studies. Here, as illustrated in FIGS. 11A to 11C, Examples 11 to 13 in which the number of parasitic elements was 0 to 2 was prepared (the unit of the numerical value was mm). Moreover, Example 14 in which the same two parasitic elements were disposed above the parasitic element of Example 13 was prepared. That is, Example 14 includes four parasitic elements.

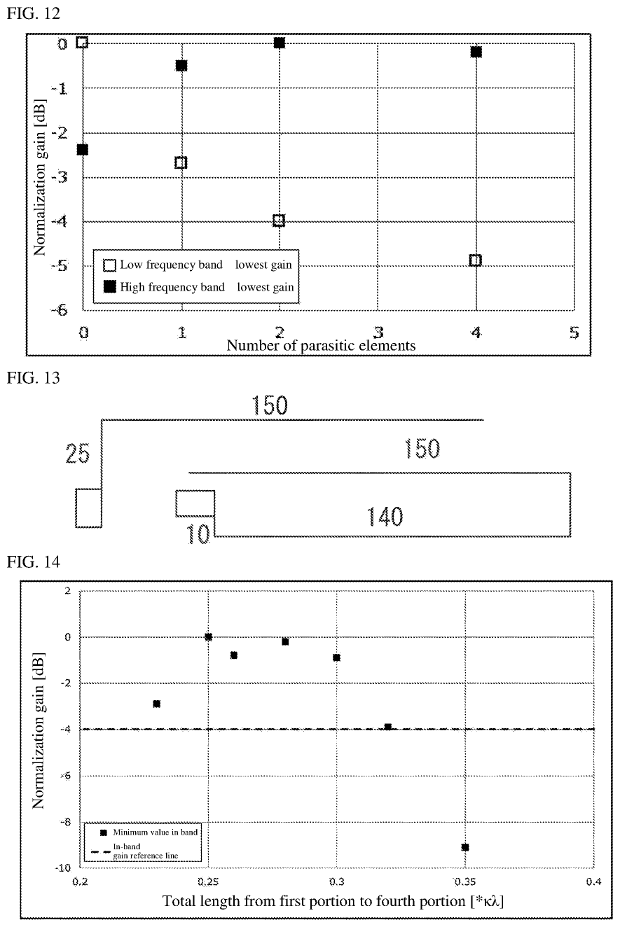

Each of the first digital television antennas of Examples 11 to 14 was formed on a glass plate. Then, each glass plate was assembled to a window frame of an automobile, directional characteristics on a horizontal plane were measured while changing an irradiation angle of a radio wave, and an average gain was calculated. The measurement of the directional characteristics was performed in a frequency band of 470 to 710 MHz. Results are as illustrated in FIG. 12. Note that FIG. 12 separately illustrates the results in the low frequency range (470 to 575 MHz) and the High frequency range (575 to 710 MHz).

According to FIG. 12, it has been found that a normalization gain in the low frequency band decreases and a normalization gain in the high frequency band increases as the number of parasitic elements increases. Therefore, it has been found that the gains in the low frequency band and the high frequency band of the antenna can be adjusted by increasing or decreasing the number of parasitic elements. Actually, it is possible to adjust the optimum number depending on a vehicle body design and a device arrangement. Note that, in Example 14, although the normalization gain of the low frequency band decreases as illustrated in FIG. 12, there is a usable level.

### <5. Study 1 on Shape of DAB Antenna>

Next, a shape of the DAB antenna will be studied. Hereinafter, a total length of the first to fourth portions of the first element of the DAB antenna as illustrated in FIG. 13 has been studied. In Examples 15 to 21, the total lengths of the first to fourth portions are approximately 0.22κ·λ, 0.25κ·λ, 0.26κ·λ, 0.28κ·λ, 0.30κ·λ, 0.32κ·λ, and 0.35κ·λ, respectively. FIG. 13 illustrates Example 19 (the unit of the numerical value is mm), and in Examples 15 to 18, 20, and 21, the lengths of the first to fourth portions are adjusted so as to have the above-described total length based on the dimension illustrated in Example 19. Note that the wavelength shortening rate κ of the glass plate is 0.7, the center frequency of the test wave (175 to 240 MHz) is 207 MHz, and the wavelength thereof is λ (=1450 mm). This point is the same in Examples described later.

Each of the DAB antennas of Examples 15 to 21 was formed on a glass plate. Then, each glass plate was assembled to a window frame of an automobile, directional characteristics on a horizontal plane were measured while changing an irradiation angle of a radio wave, and an average gain was calculated. The measurement of the directional characteristics was performed in a frequency band of 175 to 240 MHz. Results are as illustrated in FIG. 14.

According to FIG. 14, it has been found that a total length from the first portion to the fourth portion is preferably 0.22κ·λ to 0.32κ·λ as a range in which a normalization gain as a reference is −4 dB or more.

### <6. Study 2 on Shape of DAB Antenna>

Hereinafter, a total length of the first to fifth portions of the first element of the DAB antenna as illustrated in FIG. 15 has been studied. In Examples 22 to 25, the total lengths of the first to fifth portions are approximately 0.32κ·λ, 0.33κ·λ, 0.40κ·λ, and 0.43κ·λ, respectively. FIG. 15 illustrates Example 24 (the unit of the numerical value is mm), and in Examples 22, 23, and 25, the lengths of the first to fifth portions are adjusted so as to have the above-described total length based on the dimension illustrated in Example 24.

Each of the DAB antennas of Examples 22 to 25 was formed on a glass plate. Then, each glass plate was assembled to a window frame of an automobile, directional characteristics on a horizontal plane were measured while changing an irradiation angle of a radio wave, and an average gain was calculated. The measurement of the directional characteristics was performed in a frequency band of 175 to 240 MHz. Results are as illustrated in FIG. 16.

According to FIG. 16, it has been found that the total length from the first portion to the fifth portion is preferably 0.32κ·λ to 0.43κ·λ as a range in which a normalization gain as a reference is −4 dB or more.

### DESCRIPTION OF REFERENCE SIGNS

1: Glass plate
2: Light shielding layer
3: Defogger
4: First digital television antenna (first antenna)
41: Hot portion
42: Ground part
43: First element
44: Second element
45: Parasitic element
5: Second digital television antenna (second antenna)
51: Hot portion
52: Ground part
53: First element
54: Second element

1. A vehicle window glass comprising:
a glass plate;
a light shielding layer laminated on a peripheral edge portion of the glass plate;
a defogger at least partially disposed in a light-transmissive region surrounded by the light shielding layer in the glass plate; and
a first antenna disposed below the defogger in the glass plate,
wherein, in the light shielding layer, a width in a vertical direction of a portion laminated on an upper end portion of the glass plate is 25 to 200 mm, and
a1+b1≥0.52 is satisfied, where among lengths of the light-transmissive region, a1 is a horizontal length at a center portion of the glass plate in a vertical direction, b1 is a vertical length at a center portion of the glass plate in a horizontal direction, and λ is a wavelength of a center frequency of a radio wave received by the first antenna.

2. The vehicle window glass according to claim 1, wherein
the first antenna includes:
a first connection point;
a second connection point;
a first element extending from the first connection point; and
a second element extending from the second connection point, and
the first element includes:
a first portion extending downward from the first connection point;
a second portion extending in the horizontal direction from a lower end portion of the first portion;
a third portion extending upward from an end portion of the second portion; and
a fourth portion extending to a side of the first connection point from an upper end of the third portion.

3. The vehicle window glass according to claim 2, wherein the first element further includes a fifth portion connected to an upper end portion of the third portion and extending in the horizontal direction in a direction away from the first connection point.

4. The vehicle window glass according to claim 2, wherein
the first antenna includes a digital television antenna, and
a total length of the first portion to the fourth portion is in a range of 0.75κ·λ to 1.30κ·λ, where κ is a wavelength shortening rate in glass.

5. The vehicle window glass according to claim 3, wherein
the first antenna includes a digital television antenna, and
a total length of the first portion to the fifth portion is in a range of 0.95κ·λ to 1.33κ·λ, where κ is a wavelength shortening rate in glass.

6. The vehicle window glass according to claim 2, further comprising at least one parasitic element extending in the horizontal direction above the fourth portion of the first element.

7. The vehicle window glass according to claim 1, further comprising
a second antenna,
wherein the first antenna and the second antenna are disposed so as to sandwich a center of the glass plate in the horizontal direction, and
the first antenna and the second antenna have an asymmetric shape with the center interposed between the first antenna and the second antenna.

8. The vehicle window glass according to claim 7, wherein the first antenna and the second antenna are configured to receive a broadcast wave in a UHF band.

9. The vehicle window glass according to claim 7, wherein the first antenna and the second antenna are configured to receive a horizontally polarized wave.

10. The vehicle window glass according to claim 7, wherein
the defogger includes a pair of bus bars and a plurality of heating wires extending between the pair of bus bars and arranged in parallel in the vertical direction,
the first antenna is disposed below a lowermost heating wire of the heating wires, and
the second antenna is disposed between the lowermost heating wire and a second heating wire from a bottom of the heating wires.

11. The vehicle window glass according to claim 7, wherein
the second antenna includes:
a third connection point;
a fourth connection point;
a third element extending from the third connection point; and
a fourth element extending from the fourth connection point, and
the third element includes a sixth portion extending upward from the third connection point, and a seventh portion extending in the horizontal direction from an upper end of the sixth portion.

12. The vehicle window glass according to claim 2, wherein
the first antenna includes a DAB antenna, and
a total length of the first portion to the fourth portion is in a range of 0.22κ·λ to 0.32κ·λ, where κ is a wavelength shortening rate in glass.

13. The vehicle window glass according to claim 3, wherein
the first antenna includes a DAB antenna, and
a total length of the first portion to the fifth portion is in a range of 0.32κ·λ to 0.43κ·λ, where κ is a wavelength shortening rate in glass.
